(19) United States
(12) Patent Application Publication
(10) Pub. No.: US 2010/0070640 A1
(43) Pub. Date: Mar. 18, 2010

(54) METHOD AND SYSTEM FOR ALLOWING ACCESS TO PRESENTATION MATERIALS FOR A MEETING

(76) Inventors: Lloyd W. Allen, JR., Cary, NC (US); Jana H. Jenkins, Raleigh, NC (US); Steven M. Miller, Cary, NC (US)

Correspondence Address: MOORE & VAN ALLEN, PLLC For IBM, P.O. Box 13706, Research Triangle Park, NC, 27709, US

(21) Appl. No.: 12/210,677

(22) Filed: Sep. 15, 2008

(51) Int. Cl. G06F 15/16

(52) U.S. Cl. 709/229

(57) ABSTRACT

A method for allowing access to presentation materials for one or more meetings may include receiving a call from a meeting participant using a communications device. The meeting participant may use the communications device to call a prearranged teleconference number to participate in the meeting via the communications device. The method may also include sending a prompt to the meeting participant's communications device to request if the meeting participant needs to access and acquire the presentation materials to participate in the meeting. In response to the meeting participant requesting to access and acquire the presentation materials, a response may be sent to the meeting participant. In accordance with one embodiment of the present invention, the response may include sending the presentation materials to a destination entered in the communications device by the meeting participant. In accordance with another embodiment of the present invention, the response may include sending access information to the communication device for the user to access the presentation materials. The method may further include connecting the meeting participant to the meeting for participation via the communications device, if the meeting is already in progress.

### BACKGROUND OF THE INVENTION

The present invention relates to teleconferencing or meetings between individuals at remote locations, and more particularly to allowing access to presentation materials for a meeting.

Often times when a meeting or conference call is being organized, the meeting chair or organizer may have a selected invitee or participant list. This list may also constitute a distribution list for presentation materials that may be available before or at the time of the meeting. Additional, supplemental or revised materials may also only be available at the time of the meeting. Depending upon the type of conference call, some participants may receive meeting information from a different source than the original meeting chair or organizer. For example, someone from the original invitee or participant list may forward the meeting invitation to one of their colleagues or members of the same team or organization, or the meeting invitation may be forwarded to a particular group of individuals who are not on the original list. This situation may result in potential issues and effective participation in the meeting or conference call because not all of the meeting participants joining the conference call will have access to or know where to go on a network or other arrangement to acquire any presentation materials or other information. The presentation materials or information for accessing the presentation materials may only be sent to the original invitees or participants or only these individuals may be provided authorization to access the materials. The “extended” or additional participants not on the original list may then need to interrupt the conference call as to where or how they can access or acquire the presentation materials. Such interruptions can throw a speaker on the conference call off track and cause delays or other issues when time constraints exist and the agenda may be tight. Such interruptions can also create excess noise, for example, when a conference call is being recorded and can create unnecessary distractions which can take the momentum out of the conference call. Such a participant might also want to receive a copy of the meeting documents before the scheduled start of the meeting so as to have time to become thoroughly familiar with what is to be discussed.

### BRIEF SUMMARY OF THE INVENTION

In accordance with an embodiment of the present invention, a method for allowing access to presentation materials for a meeting may include receiving a call from a meeting participant. The meeting participant may call a prearranged teleconference number to participate in the meeting. The method may also include sending a prompt to the meeting participant to request if the meeting participant needs to access and acquire the presentation materials to participate in the meeting. In response to the meeting participant requesting to access and acquire the presentation materials for a particular meeting a response may be sent to the meeting participant. In accordance with one aspect of the present invention, the response may include sending the presentation materials for that meeting to a destination entered in the communications device by the meeting participant. In accordance with another aspect of the present invention, the response may include sending access information to the communication device for the user to access the presentation materials. The method may further include connecting the meeting participant to the meeting for participation via a communications device, if the meeting is already in progress.

In accordance with another embodiment of the present invention, a method for allowing access to presentation materials for a meeting may include receiving a call from a meeting participant using a communications device. The meeting participant may use the communications device to call a prearranged teleconference number to participate in the meeting via the communications device. The method may also include sending a prompt to the meeting participant's communications device to request if the meeting participant needs to access and acquire the presentation materials to participate in the meeting. The method may permit at least one of the following: the meeting participant may be allowed access to the presentation materials via the communications device or another electronic device in response to the presentation materials not being available prior to the meeting; the meeting participant may be allowed access to the presentation materials in response to the meeting participant not being on a meeting organizer's original participant list; the meeting participant may be allowed access to the presentation materials when the meeting participant is away from their primary work location; and the meeting participant may be notified and allowed access to additional presentation materials made available at meeting time. In response to the meeting participant requesting to access and acquire the presentation materials, one of the following may be performed: sending the presentation materials to a destination entered in the communications device by the meeting participant, and sending access information to the communication device for the user to access the presentation materials. The method may further include connecting the meeting participant to the meeting for participation via the communications device, if the meeting is already in progress.

In accordance with another embodiment of the present invention, a method for allowing access to presentation materials for a meeting may include receiving a call from a meeting participant using a communications device. The method may also include sending a prompt to the meeting participant's communications device to request if the meeting participant needs to access and acquire the presentation materials to participate in a particular meeting when there are several upcoming meetings that the user is allowed to attend. In response to the meeting participant requesting to access and acquire the particular presentation materials for a meeting, prompting the meeting participant to enter information for sending the presentation materials to the destination selected by the meeting participant. Prompting the meeting participant to enter information for sending the presentation materials may include requesting the meeting participant to identify the meeting, to select to receive the presentation materials by way of one of a group including email, instant messaging, directly to the meeting participant's communications device or by some other communications mode or means. The meeting participant will be prompted to enter an email address in response to the meeting participant selecting to receive the presentation materials by way of email. The meeting participant will be prompted to enter an instant messaging identification in response to the meeting participant selecting to receive the presentation materials by way of instant messaging. And the meeting participant will be prompted to enter a phone number for the communications device or the phone number for the participant's communications device may be acquired by way of caller identification in response to the meeting participant selecting to receive the presentation materials directly to the meeting participant's communications device. The meeting participant may then be connected to the meeting for participation via the communications device.

In accordance with another embodiment of the present invention, a system for allowing access to presentation materials for a meeting may include a teleconference system for receiving a call from a meeting participant. The meeting participant may call a prearranged teleconference number to participate in the meeting. The system may also include a module for sending a prompt to the meeting participant to request if the meeting participant needs to access and acquire the presentation materials to participate in the meeting and for sending a response to the meeting participant in response to the meeting participant requesting to access and acquire the presentation materials. A call management system may connect the meeting participant to the meeting, and a database may be provided for storing the presentation materials.

In accordance with a further embodiment of the present invention, a computer program product for allowing access to presentation materials for a meeting may include a computer usable medium having computer usable program code embodied therein. The computer usable medium may include computer usable program code configured to receive a call from a meeting participant, wherein the meeting participant calls a prearranged teleconference number to participate in the meeting. The computer usable medium may also include computer usable program code configured to send a prompt to the meeting participant to request if the meeting participant needs to access and acquire the presentation materials to participate in the meeting. The computer usable medium may additionally include computer usable program code configured to send a response to the meeting participant in response to the meeting participant requesting to access and acquire the presentation materials and computer usable program code configured to connect the meeting participant to the meeting.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for allowing access to presentation materials for a meeting in accordance with an embodiment of the present invention.

FIG. 2 is a block schematic diagram of an example of a system for allowing access to presentation materials in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could be any suitable medium upon which the program may be stored or electronically captured and then compiled, interpreted, or otherwise processed in a suitable manner. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate means, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

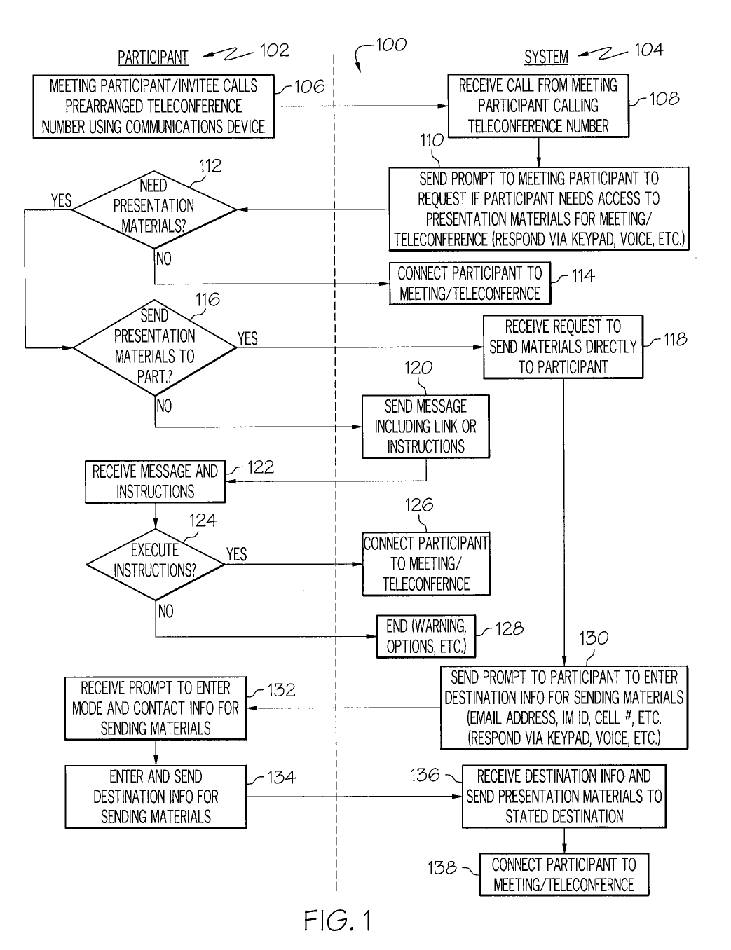

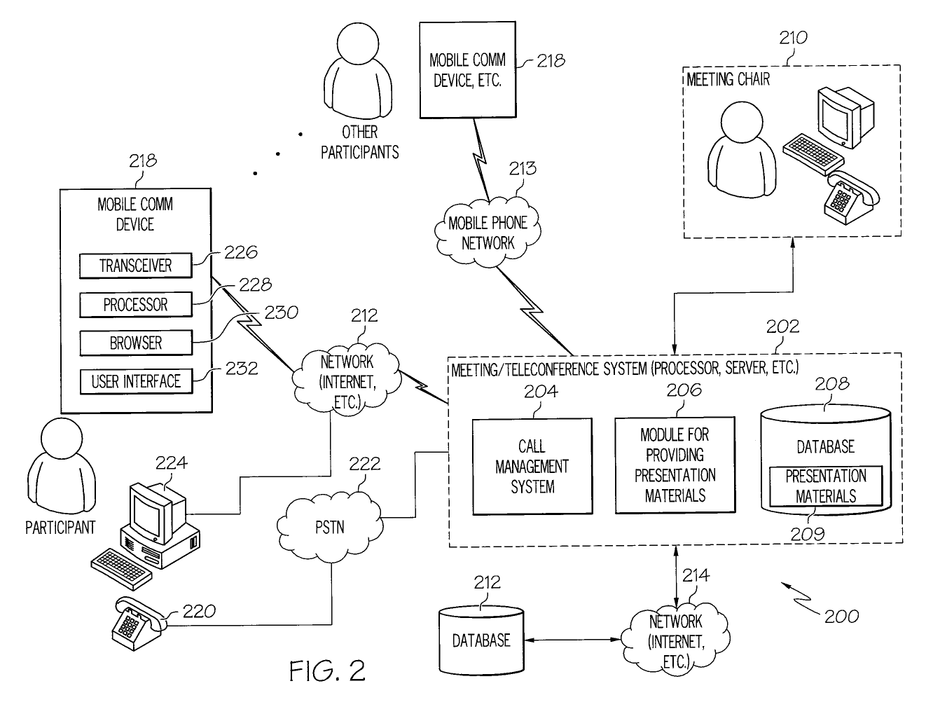

FIG. 1 is a flow chart of an example of a method 100 for allowing access to presentation materials for a meeting in accordance with an embodiment of the present invention. The method 100 may include participant operations 102 or functions that may be performed by a user or meeting participant or by the meeting participant's communications device and system operations 104 or functions that may be performed by a system, such as a meeting or teleconferencing system. As described in more detail with reference to FIG. 2, the participant's communications device may be a cellular phone, a personal data assistant (PDA) with wireless communications capability, a laptop computer, handheld computer device, desk top computer, landline telephone, a combination of these devices or any type of communications device or devices that may permit a participant to participate in a conference call and to access and acquire presentation materials associated with the meeting or conference call as described herein. The meeting or teleconference system may be a processor or server or may be operable on a processor or server or similar apparatus as described in more detail with reference to FIG. 2.

In block 106, a meeting participant or invitee may call a prearranged teleconference number using a communications device similar to that previously described. In block 108, the call from the meeting participant may be received by the meeting or teleconference system.

In block 110, a prompt may be sent by the system to the meeting participant to request if the participant needs access to or to acquire any presentation materials for the teleconference. In block 112, the prompt or request may be presented to the participant. The prompt may be a voice or audio prompt or a visual prompt, such as a text message presented on the participant's communications device. The participant may be permitted to respond to the prompt in various ways, which may be dependent on how the prompt is presented. For example, the participant may be able to enter the response via voice, via a keypad or keyboard, or by some other mechanism.

The participant may be advised in block 112 if there are new, revised, or supplemental presentation materials at the time of the meeting, or if the presentation materials are only available at the time of the meeting. This may assist the participant in deciding whether he needs to access or acquire the presentation materials when prompted.

If the participant responds in block 112 that presentation materials at not needed, the method 100 may advance to block 114 and the participant may be connected directly to the teleconference. If the participant responds in block 112 that presentation materials are needed, the method 100 may advance to block 116.

In block 116, the participant may be asked if he wants the presentation materials sent directly to him of if he wants to access the presentation materials on his own. If the participant responds that he does want the presentation materials sent directly to him or directly to his communications device the method 100 may advance to block 118. In block 118, the request to send the materials directly to the participant is received by the system.

If the participant responds that he does not want the presentation materials sent directly to him or that he wants to access the materials himself, this indication is transmitted to the system and the method 100 advances to block 120. In block 120, a message including a link to access the presentation instructions over a network, such as the Internet may be sent to the participant, or instructions for accessing the presentation instructions may be sent to participant. The message may be a voice message, a text message, or other form of messaging.

In block 122, the message including the link or instructions may be received by the participant's communications device. In block 124, a determination may be made if the participant executed the instructions. If the participant executed the instructions, the method 100 may advance to block 126. In block 126, the participant may be connected to the meeting or teleconference and the participant can use the link or follow the instructions to access and/or acquire the presentation materials.

If the participant does not execute the instructions in block 124, the method 100 may terminated at block 128. A warning or other options may be presented to the participant before termination of the method 100. For example, the participant may be offered the option to join the teleconference without accessing or acquiring the presentation materials.

Returning to block 116, as previously described, if the participant selects to be sent the presentation materials rather accessing the materials on his own, the method 100 advances to block 118. In block 118, the request to send the materials directly to the participant is received by the system. In block 130, a prompt may be sent to the participant to enter destination information for sending the materials. The participant may be presented a list of different communications modes available for sending the presentation materials to the participant and the participant may be requested to select a communications mode from the list or group. Examples of the different modes may include email, instant messaging, transmission directly to the participant's communications device, or some other similar communications mode or technology.

In block 132, the participant may receive the prompt or request to enter or select a destination or communications mode and contact information or addressing information associated with the communications mode selected. The participant may be requested to enter an email address by the interactive system in response to the meeting participant selecting to receive the presentation by way of email. The participant may be requested to enter an instant messaging identification in response to the meeting participant selecting to receive the presentation materials via instant messaging. The participant may be requested to enter a phone number for the participant's communications device or the phone number may be acquired automatically by caller identification in response to the participant selecting to receive the presentation materials directly to the meeting participant's communications device. In block 134, the meeting participant may enter and send the destination information for sending the presentation materials similar to that described above.

In block 136, the destination information or addressing information for the communications mode by which the presentation materials will be sent may be received by the system. The presentation materials may then be sent to the designated destination. In block 138, the participant may be connected to the teleconference or meeting via the participant's communications device or other device.

FIG. 2 is a block schematic diagram of an example of a system 200 for allowing access to presentation materials in accordance with an embodiment of the present invention. Elements or portions of the method 100 may be embodied in and performed by components of the system 200. The system 200 may include a meeting or teleconference system 202. The functions or operations 104 of FIG. 1 may be embodied in and performed by the teleconference system 202. The teleconference system 202 may be embodied in a processor, server or other device capable of performing the operations described herein.

The teleconference system 202 may include a call management system 204 to manage interconnection of the communications between the different participants on the teleconference. The teleconference system 202 may also include a module 206 for maintaining and providing the presentation materials to the participants similar to that described with reference to FIG. 1.

A database 208 may also be associated with the teleconference system 202. The database 208 may store the presentation materials 209. The database 208 may store presentation materials for multiple different teleconferences that may be occurring simultaneously or that are scheduled for a future date. The database 208 may also store presentation materials 209 for a period of time after the teleconference depending upon the desires of a teleconference chair 210 or organizer or retention options selected.

In another embodiment of the present invention, another database 212 for storing presentation materials may be accessed via a network 214 by the teleconference system 202. The database 212 may be in addition to the database 208 or may be an alternative to the database 208 on the teleconference system 202.

The meeting chair 210 or organizer may access the teleconference system 202 to schedule the teleconference and to post the presentation materials 209.

As previously discussed, a meeting participant 216 may call a prearranged teleconference number using a communications device. The communications device may be a mobile communications device 218 similar to that previously described or some other type of communications device. For example, the communications device may also be a standard landline telephone 220 connectable to the teleconference via a public switched telephone network (PSTN) 222, and the participant 216 may access the presentation materials via a desk top computer 224 or other computing device.

The exemplary mobile communications device 218 may include a transceiver 226 for sending and receiving voice communications and data including the presentation materials. The mobile communications device 218 may include a processor 228 to control operation of the communications device and to perform the operations described herein. A browser 230 may be included to facilitate accessing the presentation materials via a network 212, such as the Internet, mobile phone network 213, or both or some other wireless communications network. The mobile communications device 218 may further include a user interface 232 for the participant 216 to control operation of the communications device 218, for participating in the teleconference and for accessing the presentation materials. The user interface 232 may include a display screen, keypad or keyboard, microphone, and speaker for voice and audio communications.

The flowcharts and block diagrams in FIGS. 1 and 2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for allowing access to presentation materials for a meeting, comprising:
receiving a call from a meeting, wherein the meeting participant calls a prearranged teleconference number to participate in the meeting;
sending a prompt to the meeting participant to request if the meeting participant needs to access and acquire the presentation materials to participate in the meeting;
sending a response to the meeting participant in response to the meeting participant requesting to access and acquire the presentation materials; and
connecting the meeting participant to the meeting for participation.

2. The method of claim 1, wherein sending the response to the meeting participant in response to the meeting participant requesting to access and acquire the presentation materials comprises sending access information to the meeting participant to access the presentation materials.

3. The method of claim 1, wherein sending the response to the meeting participant in response to the meeting participant requesting to access and acquire the presentation materials comprises sending the presentation materials to a destination provided by the meeting participant.

4. The method of claim 3, further comprising prompting the meeting participant to enter information for sending the presentation materials to the destination selected by the meeting participant.

5. The method of claim 4, wherein prompting the meeting participant to enter information for sending the presentation materials comprises:
requesting the meeting participant to select a communications mode from a list of different communications modes available for sending the presentation materials to the meeting participant; and
requesting the meeting participant to enter addressing information associated with the communications mode selected.

6. The method of claim of claim 4, further comprising allowing the information for sending the presentation materials to be entered via voice commands and via a keypad of a communications device.

7. The method of claim 4, wherein prompting the meeting participant to enter information for sending the presentation materials comprises:
requesting the meeting participant to select to receive the presentation materials by way of one of a group including email, instant messaging and directly to a communications device associated with the meeting participant;
requesting the meeting participant to enter an email address in response to the meeting participant selecting to receive the presentation materials by way of email;
requesting the meeting participant to enter an instant messaging identification in response to the meeting participant selecting to receive the presentation materials by way of instant messaging; and
requesting the meeting participant to enter a phone number for the communications device or acquiring the phone number via caller identification in response to the meeting participant selecting to receive the presentation materials directly to the communications device associated with the meeting participant.

8. The method of claim 1, wherein sending access information to the meeting participant comprises sending instructions for accessing the presentation materials via a communications device associated with the meeting participant.

9. The method of claim 8, further comprising connecting the meeting participant to the teleconference in response to the meeting participant completing the instructions.

10. The method of claim 9, further comprising sending a warning to the meeting participant that the call will be terminated within a predetermined period of time if the meeting participant does not complete the instructions.

11. The method of claim 9, further comprising allowing the meeting participant to select an option to join the meeting without accessing the presentation materials or to terminate the call in response to the meeting participant failing to execute the instructions within a predetermined time period.

12. The method of claim 1, wherein sending access information to the meeting participant comprises sending a network link to the meeting participant for accessing the presentation materials over a network.

13. The method of claim 1, further comprising allowing access to the presentation materials via a communications device or another electronic device in response to the presentation materials not being available prior to the meeting.

14. The method of claim 1, further comprising allowing access to the presentation materials over a network by a meeting attendee in response to the meeting attendee not being on a meeting organizer's original participant list.

15. A method for allowing access to presentation materials for a meeting, comprising:
receiving a call from a meeting participant using a communications device, wherein the meeting participant uses the communications device to call a prearranged teleconference number to participate in the meeting via the communications device; and
sending a prompt to the meeting participant's communications device to request if the meeting participant needs to access and acquire the presentation materials to participate in the meeting, wherein at least one of the meeting participant is allowed access to the presentation materials via the communications device or another electronic device in response to the presentation materials not being available prior to the meeting, the meeting participant is allowed access to the presentation materials in response to the meeting participant not being on a meeting organizer's original participant list, the meeting participant is allowed access to the presentation materials when the meeting participant is away from their primary work location, and the meeting participant is notified and allowed access to additional presentation materials made available at meeting time;
in response to the meeting participant requesting to access and acquire the presentation materials, performing one of:
sending the presentation materials to a destination entered in the communications device by the meeting participant, and
sending access information to the communication device for the meeting participant to access the presentation materials; and
connecting the meeting participant to the meeting for participation via the communications device.

16. The method of claim 15, further comprising prompting the meeting participant to enter information for sending the presentation materials to the destination selected by the meeting participant.

17. The method of claim 16, wherein prompting the meeting participant to enter information for sending the presentation materials comprises:
requesting the meeting participant to select a communications mode from a list of different communications modes available for sending the presentation materials to the meeting participant; and
requesting the meeting participant to enter addressing information associated with the communications mode selected.

18. The method of 16, wherein prompting the meeting participant to enter information for sending the presentation materials comprises:
requesting the meeting participant to select to receive the presentation materials by way of one of a group including email, instant messaging and directly to the meeting participant's communications device;
requesting the meeting participant to enter an email address in response to the meeting participant selecting to receive the presentation materials by way of email;
requesting the meeting participant to enter an instant messaging identification in response to the meeting participant selecting to receive the presentation materials by way of instant messaging; and
requesting the meeting participant to enter a phone number for the communications device or acquiring the phone number via caller identification in response to the meeting participant selecting to receive the presentation materials directly to the meeting participant's communications device.

19. A method for allowing access to presentation materials for a meeting, comprising:
receiving a call from a meeting participant using a communications device, wherein the meeting participant uses the communications device to call a prearranged teleconference number to participate in the meeting via the communications device;
sending a prompt to the meeting participant's communications device to request if the meeting participant needs to access and acquire the presentation materials to participate in one or more upcoming meetings that are scheduled for the conference number and that are accessible to the caller;
in response to the meeting participant requesting to access and acquire the presentation materials, prompting the meeting participant to enter information for sending the presentation materials to the destination selected by the meeting participant, wherein prompting the meeting participant to enter information for sending the presentation materials comprises:
requesting the meeting participant to identify the particular meeting when there are several meetings that the participant can access and that each have presentation materials;
requesting the meeting participant to select to receive the presentation materials by way of one of a group including email, instant messaging and directly to the meeting participant's communications device;
requesting the meeting participant to enter an email address in response to the meeting participant selecting to receive the presentation materials by way of email;
requesting the meeting participant to enter an instant messaging identification in response to the meeting participant selecting to receive the presentation materials by way of instant messaging;
requesting the meeting participant to enter a phone number for the communications device or acquiring the phone number via caller identification in response to the meeting participant selecting to receive the presentation materials directly to the meeting participant's communications device; and
connecting the meeting participant to the meeting for participation via the communications device.

20. A system for allowing access to presentation materials for a meeting, comprising:
a teleconference system for receiving a call from a meeting participant, wherein the meeting participant calls a prearranged teleconference number to participate in the meeting;
a module for sending a prompt to the meeting participant to request if the meeting participant needs to access and acquire the presentation materials to participate in the meeting and for sending a response to the meeting participant in response to the meeting participant requesting to access and acquire the presentation materials;
a call management system to connect the meeting participant to the meeting; and
a database for storing the presentation materials.

21. A computer program product for allowing access to presentation materials for a meeting, the computer program product comprising:
a computer usable medium having computer usable program code embodied therein, the computer usable medium comprising:
computer usable program code configured to receive a call from a meeting participant, wherein the meeting participant calls a prearranged teleconference number to participate in the meeting;
computer usable program code configured to send a prompt to the meeting participant to request if the meeting participant needs to access and acquire the presentation materials to participate in the meeting;
computer usable program code configured to send a response to the meeting participant in response to the meeting participant requesting to access and acquire the presentation materials; and
computer usable program code configured to connect the meeting participant to the meeting for participation.
